(19) United States
(12) Patent Application Publication
(10) Pub. No.: US 2014/0168066 A1
(43) Pub. Date: Jun. 19, 2014

(54) METHOD AND ELECTRONIC DEVICE FOR CONTROLLING DATA TRANSMISSION

(71) Applicant: Lenovo (Beijing) Co., Ltd., Beijing (CN)

(72) Inventors: Qiming Deng, Beijing (CN); Shiguang Huang, Beijing (CN); Dong Chen, Beijing (CN); Zezhong Wen, Beijing (CN); Yanxia Chen, Beijing (CN)

(73) Assignee: Lenovo (Beijing) Co., Ltd., Beijing (CN)

(21) Appl. No.: 14/099,378

(22) Filed: Dec. 6, 2013

(30) Foreign Application Priority Data
Dec. 14, 2012 (CN) 201210546047.9

(51) Int. Cl. G06F 3/01

(52) U.S. Cl. CPC G06F 3/01
USPC 345/156

(57) ABSTRACT

A method and an electronic device for controlling data transmission are disclosed in the embodiment of the present invention. Data transmission may be controlled by detecting a first input operation and a second input operation; generating a first coordinate of an input point corresponding to the first input operation and a second coordinate of an input point corresponding to the second input operation; identifying the first coordinate and the second coordinate, and determining the coordinate corresponding to the first display region and the coordinate corresponding to the second display region; obtaining address information which corresponds to the coordinate corresponding to the first display region; determining file address information which corresponds to the coordinate corresponding to the second display region according to a correspondence between coordinate information and the file address information of the second electronic device; generating and sending a data transmission control instruction carrying the file address information.

This application claims priority to Chinese patent application No. 201210546047.9 titled “method and electronic device for controlling data transmission” and filed with the State Intellectual Property Office on Dec. 14, 2012, which is incorporated herein by reference in its entirety.

### FIELD OF THE INVENTION

The invention relates to the technical field of data processing, and in particular to a method and an electronic device for controlling data transmission.

### BACKGROUND OF THE INVENTION

Nowadays, data transmission between electronic devices can be performed by wireless communication. For example, data transmission between two mobile phones can be performed via Bluetooth.

However, it is necessary for a user to operate the electronic device frequently when transmitting data between electronic devices, which results in a long time and low efficiency for data transmission.

### SUMMARY OF THE INVENTION

In view of the above, the present invention provides a method and an electronic device for controlling data transmission, to solve the problem in the prior art of long time and low efficiency for data transmission due to the frequent operation of electronic devices by the user to accomplish data transmission.

To achieve the above object, there are now provided the following solutions:

a method for controlling data transmission, which is applied in a first electronic device, a display interface of the first electronic device includes at least two display regions; a first display region displays information of the first electronic device or a third electronic device, and a second display region displays file information of a second electronic device; the method including:

detecting a first input operation obtained in the first display region or the second display region;

generating a first coordinate of an input point corresponding to the first input operation;

detecting a second input operation obtained in a display region other than the display region corresponding to the first input operation;

generating a second coordinate of an input point corresponding to the second input operation;

identifying the first coordinate and the second coordinate, and determining the coordinate corresponding to the first display region and the coordinate corresponding to the second display region;

obtaining address information which corresponds to the coordinate corresponding to the first display region;

determining file address information which corresponds to the coordinate corresponding to the second display region according to a correspondence between coordinate information and the file address information of the second electronic device;

generating and sending a data transmission control instruction carrying the file address information to the second electronic device; and

controlling the data transmission between an address corresponding to the file address information and an address corresponding to the address information in response to the data transmission control instruction.

Preferably, before the detecting a first input operation, the method further includes:

detecting that the second electronic device is in a predetermined range of the first electronic device;

acquiring identification information of the second electronic device, and establishing wireless connection with the second electronic device;

acquiring the file address information of the second electronic device;

generating a correspondence between the file address information of the second electronic device and coordinate information corresponding to the second display region of the first electronic device; and

outputting the file information of the second electronic device.

Preferably, after the detecting a first input operation, the method further includes:

acquiring input information corresponding to the first input operation; and

determining that the input information is predetermined information, and acquiring control instruction information corresponding to the predetermined information; and

the generating and sending a data transmission control instruction carrying the file address information to the second electronic device is: generating and sending the data transmission control instruction carrying the file address information to the second electronic device according to the control instruction information.

Preferably, the obtaining address information which corresponds to the coordinate corresponding to the first display region includes:

determining whether there is a corresponding file to the coordinate corresponding to the first display region;

acquiring address information of the corresponding file as the address information which corresponds to the coordinate corresponding to the first display region, if there is the corresponding file; and

acquiring preset address information as the address information which corresponds to the coordinate corresponding to the first display region, if there is no corresponding file.

Preferably, after the data transmission, the method further includes:

determining whether the sender of the data is the second electronic device;

determining whether the transmitted data belongs to data of an application, if the sender of the data is the second electronic device; and

controlling the execution of the application, if the transmitted data belongs to the data of the application.

Preferably, the obtaining address information which corresponds to the coordinate corresponding to the first display region in the case where the first display region displays the information of the third electronic device includes:

determining a file of the third electronic device which corresponds to the coordinate corresponding to the first display region; and

acquiring file address information of the third electronic device as the address information which corresponds to the coordinate corresponding to the first display region.

An electronic device, including:

a display unit, a display interface of which including at least two display regions, wherein a first display region displays information of the electronic device or a third electronic device, and a second display region displays file information of a second electronic device;

a first detection unit, adapted to detect a first input operation and a second input operation, wherein the first input operation is obtained in the first display region or the second display region, and the second input operation is obtained in a display region other than the display region corresponding to the first input operation;

a processor, adapted to generate a first coordinate of an input point corresponding to the first input operation and a second coordinate of an input point corresponding to the second input operation; identify the first coordinate and the second coordinate, and determine the coordinate corresponding to the first display region and the coordinate corresponding to the second display region; obtain address information which corresponds to the coordinate corresponding to the first display region; determine file address information of the coordinate corresponding to the second display region according to a correspondence between coordinate information and the file address information of the second electronic device; and generate a data transmission control instruction carrying the file address information; and

a communication unit, adapted to send the data transmission control instruction to the second electronic device; and control data transmission between an address corresponding to the file address information and an address corresponding to the address information in response to the data transmission control instruction;

wherein the electronic device further includes a memory storing control code for controlling the operation of the processor.

Preferably, the electronic device further includes:

a second detection unit, adapted to detect whether the second electronic device is in a predetermined range of the electronic device;

wherein the memory further stores control code for controlling the processor to acquire identification information of the first electronic device and establish wireless connection with the first electronic device; acquiring file address information of the first electronic device; and generating a correspondence between the file address information of the first electronic device and coordinate information corresponding to the second display region for the second electronic device, in the case where it is detected by the second detection unit that the second electronic device is in the predetermined range of the electronic device;

Preferably, the memory further stores control code for controlling the processor to acquire input information corresponding to the first input operation; determining that the input information is predetermined information and acquiring control instruction information corresponding to the predetermined information; and

the specific manner for the processor to generate a data transmission control instruction carrying the file address information includes: generating the data transmission control instruction carrying the file address information according to the control instruction information.

Preferably, the specific manner for the processor to obtain address information which corresponds to the coordinate corresponding to the first display region includes:

determining whether there is a corresponding file to the coordinate corresponding to the first display region;

acquiring address information of the corresponding file as the address information which corresponds to the coordinate corresponding to the first display region, if there is the corresponding file; and

acquiring preset address information as the address information which corresponds to the coordinate corresponding to the first display region, if there is no corresponding file.

Preferably, the memory further stores control code for controlling the processor to determine whether the sender of the data is the second electronic device after the data transmission is accomplished by the electronic device; determine whether the transmitted data belongs to data of an application, if the sender of the data is the second electronic device; and generate a control instruction to control the execution of the application, if the transmitted data belongs to the data of the application;

Preferably, the specific manner for the processor to obtain address information which corresponds to the coordinate corresponding to the first display region in the case where the first display region of the display unit displays the information of the third electronic device is: determining a file of the third electronic device which corresponds to the coordinate corresponding to the first display region; and

acquiring file address information of the third electronic device as the address information which corresponds to the coordinate corresponding to the first display region.

The above-mentioned technical solution shows that, in the method for controlling data transmission according to the present invention, the user is only needed to perform an input operation in the first display region and the second display region of the first electronic device then data transmission may be controlled through the following steps: detecting a first input operation; generating a first coordinate of an input point corresponding to the first input operation; detecting a second input operation; generating a second coordinate of an input point corresponding to the second input operation; identifying the first coordinate and the second coordinate, and determining the coordinate corresponding to the first display region and the coordinate corresponding to the second display region; obtaining address information which corresponds to the coordinate corresponding to the first display region; determining file address information which corresponds to the coordinate corresponding to the second display region according to a correspondence between coordinate information and the file address information of the second electronic device; generating and sending a data transmission control instruction carrying the file address information to the second electronic device; and controlling the data transmission between an address corresponding to the file address information and an address corresponding to the address information in response to the data transmission control instruction. The operation is easy and convenient with short time and high efficiency, thereby it is solved the problem in the prior art of long time and low efficiency for data transmission due to the frequent operation of electronic devices by the user to accomplish data transmission.

### BRIEF DESCRIPTION OF THE DRAWINGS

In order to explain the technical solutions in embodiments of the present invention or the prior art more clearly, accompanying drawings of the embodiments or the prior art are briefly illustrated hereinafter. Apparently, the accompanying drawings described hereinafter are only some embodiments of the present invention, and those skilled in the art can further conceive other drawings according to the drawings without creative work.

FIG. 1 is a flowchart of a method for controlling data transmission according to an embodiment of the present invention;

FIG. 2 is a flowchart of a method for controlling data transmission according to another embodiment of the present invention;

FIG. 3(a) is an application drawing of the method for controlling data transmission according to the embodiment of the present invention;

FIG. 3(b) is another application drawing of the method for controlling data transmission according to the embodiment of the present invention;

FIG. 4 is a flowchart of a method for controlling data transmission according to another embodiment of the present invention;

FIG. 5 is a flowchart of a method for controlling data transmission according to another embodiment of the present invention;

FIG. 6 is a structural schematic diagram of an electronic device according to the embodiment of the present invention; and

FIG. 7 is an application drawing of the electronic device according to the embodiment of the present invention.

### DETAILED DESCRIPTION OF THE INVENTION

The technical solutions according to the embodiments of the present invention will be described clearly and completely as follows in conjunction with the accompanying drawings in the embodiments of the present invention. It is obvious that the described embodiments are only a part of the embodiments according to the present invention. All the other embodiments obtained by those skilled in the art based on the embodiments in the present invention without any creative effort belong to the scope of the present invention.

The embodiment of the present invention provides a method and an electronic device for controlling data transmission, to solve the problem in the prior art of long time and low efficiency for data transmission due to the frequent operation of electronic devices by the user to accomplish data transmission.

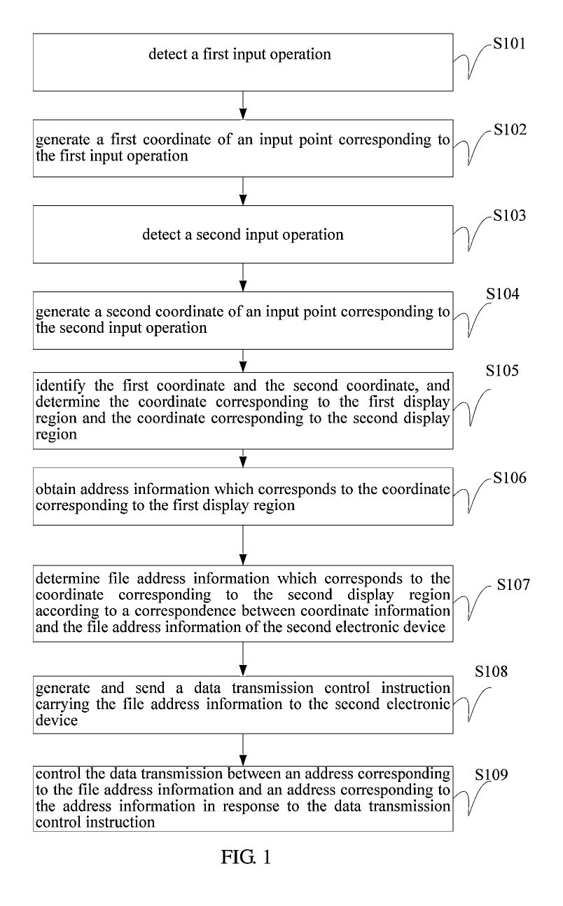

Referring to FIG. 1, the method for controlling data transmission according to the embodiment of the present invention is applied in a first electronic device. A display interface of the first electronic device includes at least two display regions; a first display region displays information of the first electronic device or a third electronic device, and a second display region displays file information of a second electronic device. The method includes the following steps.

S101: detecting a first input operation obtained in the first display region or the second display region.

Specifically, a user performs an input operation on the display interface of the first electronic device, to detect by the first electronic device in the first display region and the second display region of the display interface.

S102: generating a first coordinate of an input point corresponding to the first input operation.

Specifically, an X-Y coordinate system is established with respect to the display interface of the first electronic device, the input point of the first input operation is determined, and the position of the input point in the X-Y coordinate system is determined and the first coordinate is generated, after the first input operation is detected on the display interface of the first electronic device.

S103: detecting a second input operation obtained in a display region other than the display region corresponding to the first input operation.

Similarly, the second input operation is detected in the display region other than the display region corresponding to the first input operation, after the first input operation is detected.

S104: generating a second coordinate of an input point corresponding to the second input operation.

Specifically, the input point of the second input operation is determined, and the position of the input point in the X-Y coordinate system is determined, and the second coordinate is generated.

S105: identifying the first coordinate and the second coordinate, and determining the coordinate corresponding to the first display region and the coordinate corresponding to the second display region.

S106: obtaining address information which corresponds to the coordinate corresponding to the first display region.

Specifically, S106 includes: determining whether there is a corresponding file to the coordinate corresponding to the first display region;

acquiring address information of the corresponding file as the address information which corresponds to the coordinate corresponding to the first display region, if there is the corresponding file; and

acquiring preset address information as the address information which corresponds to the coordinate corresponding to the first display region, if there is no corresponding file.

In this way, the data may be transmitted to the file or the data stored in the file may be sent, in the case where there is a file displayed in the first display region and the file is selected by the input operation of the user; or the transmitted file may be received and stored in the first display region, i.e., the desktop of the first electronic device in the case where there is no file displayed in the first display region.

S107: determining file address information which corresponds to the coordinate corresponding to the second display region according to a correspondence between coordinate information and the file address information of the second electronic device.

Specifically, the correspondence between the coordinate information and the file address information of the second electronic device is acquired in advance, and the file address information is obtained by matching the coordinate corresponding to the second display region in the correspondence.

S108: generating and sending a data transmission control instruction carrying the file address information to the second electronic device.

S109: controlling the data transmission between an address corresponding to the file address information and an address corresponding to the address information in response to the data transmission control instruction.

The second electronic device may send or receive data after receiving the data transmission control instruction.

Specifically, the data transmission control instruction generated in S108 includes a data sending control instruction and a data acquiring control instruction. The data sending control instruction is adapted to control the transmission of data located at the address which corresponds to the coordinate corresponding to the first display region to the file address which corresponds to the coordinate corresponding to the second display region; and the data acquiring control instruction is adapted to control the transmission of data located at the file address which corresponds to the coordinate corresponding to the second display region to the address which corresponds to the coordinate corresponding to the first display region.

In this embodiment, the user is only needed to perform an input operation in the first display region and the second display region of the first electronic device, and then data transmission may be controlled by: detecting a first input operation; generating a first coordinate of an input point corresponding to the first input operation; detecting a second input operation; generating a second coordinate of an input point corresponding to the second input operation; identifying the first coordinate and the second coordinate, and determining the coordinate corresponding to the first display region and the coordinate corresponding to the second display region; obtaining address information which corresponds to the coordinate corresponding to the first display region; determining file address information which corresponds to the coordinate corresponding to the second display region according to a correspondence between coordinate information and the file address information of the second electronic device; generating and sending a data transmission control instruction carrying the file address information to the second electronic device; and controlling the data transmission between an address corresponding to the file address information and an address corresponding to the address information in response to the data transmission control instruction. The operation can be easy and convenient with short time and high efficiency, thereby it is solved the problem in the prior art of long time and low efficiency for data transmission due to the frequent operation of electronic devices by the user to accomplish data transmission.

Moreover, in this embodiment, wireless connection between the first electronic device and the second electronic device may be established in advance to implement communication between the first electronic device and the second electronic device; and the wireless connection between the first electronic device and the second electronic device may be established before the step S108.

Furthermore, in the step S107 according to the embodiment, the correspondence between the coordinate information and the file address information of the second electronic device may be acquired in advance, or may be generated before the method for controlling data transmission according to the embodiment is executed, of which the detail is shown in the following embodiment.

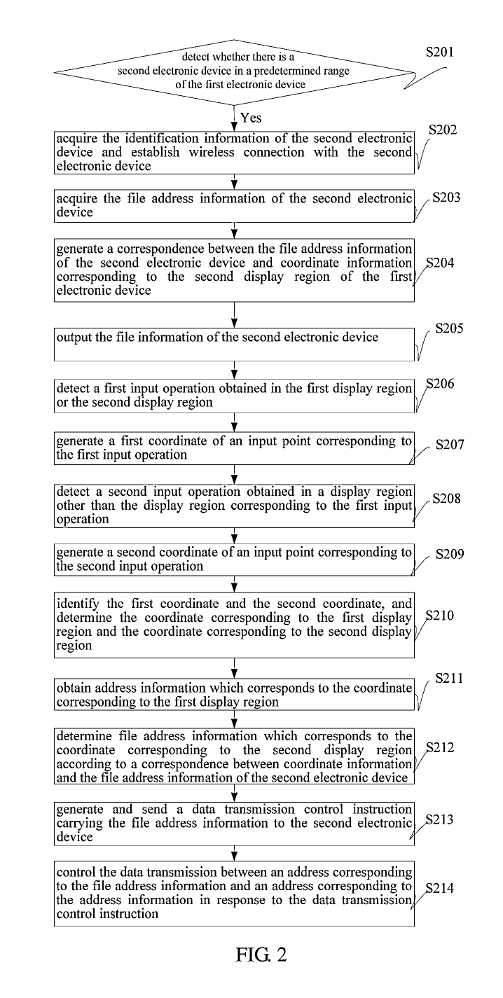

A method for controlling data transmission is disclosed in another embodiment of the present invention. As illustrated in FIG. 2, the method includes the following steps.

S201: detecting whether there is a second electronic device in a predetermined range of the first electronic device.

Specifically, the second electronic device may be detected when being placed on the display interface of the first electronic device; or the second electronic device may be detected when a radio frequency (RF) signal is emitted by the first electronic device and the second electronic device is within the detection range of the RF signal.

The step S202 is executed to acquire the identification information of the second electronic device and establish wireless connection with the second electronic device, if the second electronic device is detected.

No operation is executed, if the second electronic device is not detected.

S203: acquiring the file address information of the second electronic device.

S204: generating a correspondence between the file address information of the second electronic device and coordinate information corresponding to the second display region of the first electronic device.

Specifically, a region is delimited on all regions of the display interface of the second electronic device, as the second display region adapted to display the file information of the second electronic device. The coordinates contained in the delimited region are acquired after the region is delimited, and the correspondence between the coordinates contained in the delimited region and the files of the second electronic device is established. It may be one coordinate corresponds to one piece of file address information, alternatively, multiple adjacent coordinates may correspond to one piece of file address information.

S205: output the file information of the second electronic device.

The file information of the second electronic device is displayed in the delimited region, i.e., the second display region, and, there is a unique piece of file address information corresponding to each file information of the second electronic device. Meanwhile, it is necessary to ensure that the coordinates contained in the display region for each file information of the second electronic device are the coordinates corresponding to the file information in the correspondence generated in step S204.

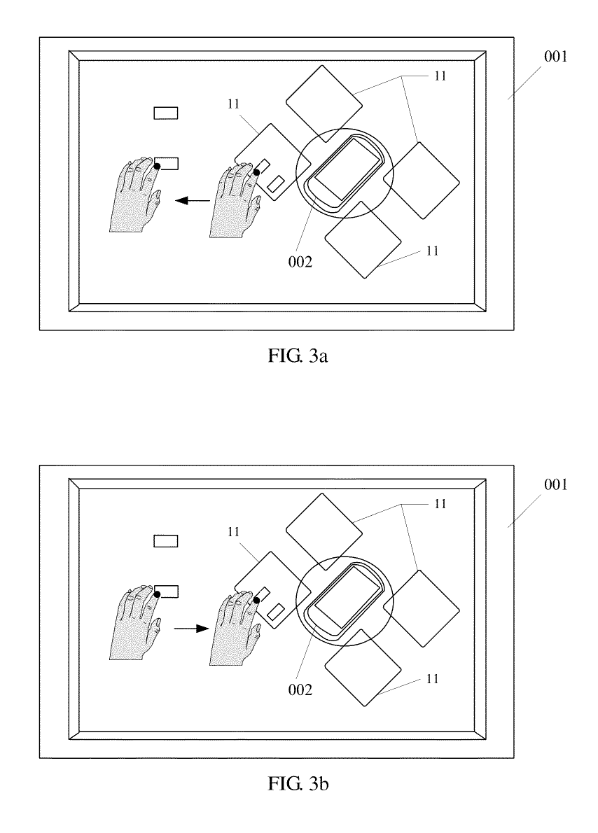

Referring to FIG. 3(a) and FIG. 3(b), the file information of the second electronic device is displayed in the second display region 11 of the first electronic device 001. And the file information of the second electronic device 002 may be divided according to attribute, and the file information with the same attribute are displayed in one display region. For example, in FIG. 3(a) and FIG. 3(b), an audio file, a video file, an picture file and an e-book file of the second electronic device 002 are displayed in four second display regions 11 respectively.

S206: detecting a first input operation obtained in the first display region or the second display region.

Referring to FIG. 3(a) and FIG. 3(b), the display interface of the first electronic device is an interactive interface. The user may perform an input operation in the display interface of the first electronic device. The user selects a file in the second display region 11 in FIG. 3 (a), or, the user selects a file in the first display region in FIG. 3 (b).

S207: generating a first coordinate of an input point corresponding to the first input operation.

S208: detecting a second input operation obtained in a display region other than the display region corresponding to the first input operation.

Similarly, referring to FIG. 3(a) and FIG. 3(b), the user drags the selected file to the first display region of the first electronic device 001 in FIG. 3(a); and the user drags the selected file to the second display region 11 of the first electronic device 001 in FIG. 3(b).

S209: generating a second coordinate of an input point corresponding to the second input operation.

S210: identifying the first coordinate and the second coordinate, and determining the coordinate corresponding to the first display region and the coordinate corresponding to the second display region.

S211: obtaining address information which corresponds to the coordinate corresponding to the first display region.

S212: determining file address information which corresponds to the coordinate corresponding to the second display region according to a correspondence between coordinate information and the file address information of the second electronic device.

Specifically, the correspondence between the coordinate information and the file address information of the second electronic device is generated in step S204.

S213: generating and sending a data transmission control instruction carrying the file address information to the second electronic device.

S214: controlling the data transmission between an address corresponding to the file address information and an address corresponding to the address information in response to the data transmission control instruction.

Similarly, referring to FIG. 3(a) and FIG. 3(b), the user drags the file displayed in the second display region 11 to the first display region of the first electronic device 001 in FIG. 3(a); and the user drags the file displayed in the first display region of the first electronic device 001 to the second display region 11 in FIG. 3(b).

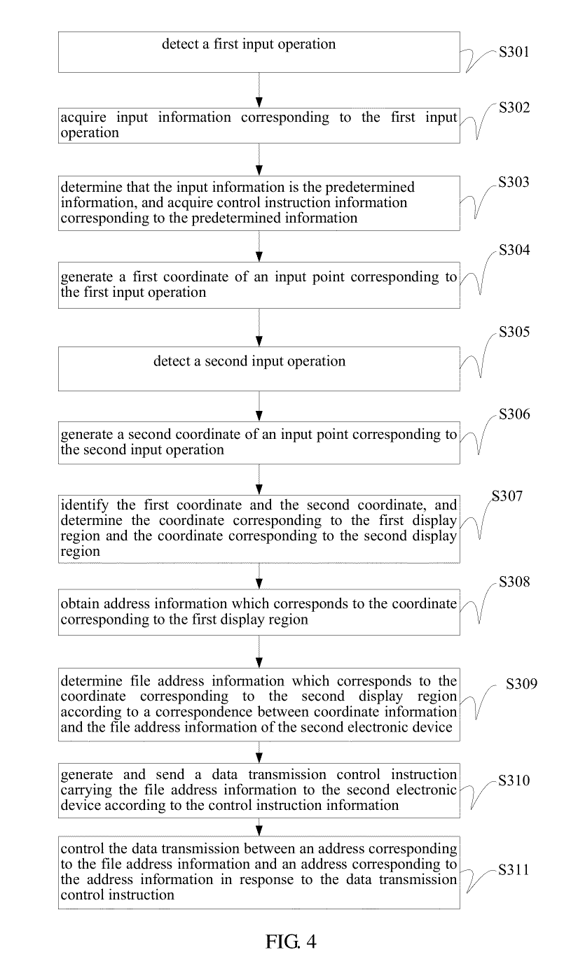

A method for controlling data transmission is further disclosed in another embodiment of the present invention. Referring to FIG. 4, the method includes the following steps.

S301: detecting a first input operation obtained in the first display region or the second display region.

S302: acquiring input information corresponding to the first input operation.

The data transmission may refer to copy data and transmit the copied data to a specified address; alternatively, the data transmission may refer to cut data to a specified address. In this case, the input information of the user are different with respect to the different types of data transmission. For example, double click on the file needed to be transmitted by the user, the data is copied and transmitted; and single click on the file to be transmitted by the user, the data is cut and transmitted.

The type of data transmission is learnt by acquiring the input information corresponding to the first input operation.

S303: determining the input information to be the predetermined information, and acquiring control instruction information corresponding to the predetermined information.

The corresponding input information is transmitted after it is determined that the input information is copying data, and the acquired control instruction information is control instruction information transmitted after copying data is controlled. The corresponding input information is transmitted after it is determined that the input information is cutting data, and the acquired control instruction information is control instruction information transmitted after cutting data is controlled.

S304: generating a first coordinate of an input point corresponding to the first input operation.

S305: detecting a second input operation obtained in a display region other than the display region corresponding to the first input operation.

S306: generating a second coordinate of an input point corresponding to the second input operation.

S307: identifying the first coordinate and the second coordinate, and determining the coordinate corresponding to the first display region and the coordinate corresponding to the second display region.

S308: obtaining address information which corresponds to the coordinate corresponding to the first display region.

S309: determining file address information which corresponds to the coordinate corresponding to the second display region according to a correspondence between coordinate information and the file address information of the second electronic device.

S310: generating and sending a data transmission control instruction carrying the file address information to the second electronic device according to the control instruction information.

Specifically, the generated data transmission control instruction is the data transmission control instruction transmitted after data is cut in the case where the control instruction information is the control instruction information transmitted after cutting data is controlled. The generated data transmission control instruction is the data transmission control instruction transmitted after data is copied in the case where the control instruction information is the control instruction information transmitted after copying data is controlled.

S311: controlling the data transmission between an address corresponding to the file address information and an address corresponding to the address information in response to the data transmission control instruction.

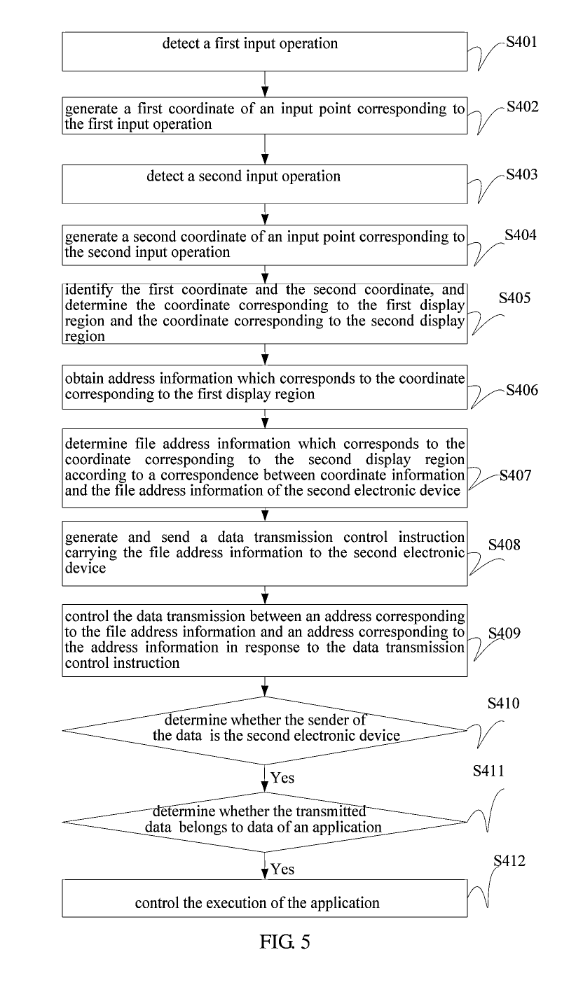

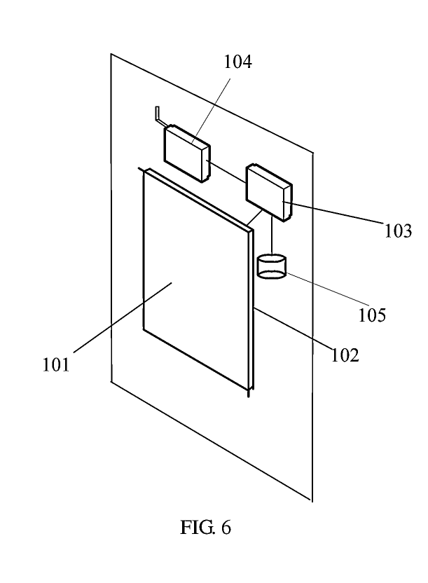

A method for controlling data transmission is further disclosed in another embodiment of the present invention. Referring to FIG. 5, the method includes the following steps.

S401: detecting a first input operation obtained in the first display region or the second display region.

S402: generating a first coordinate of an input point corresponding to the first input operation.

S403: detecting a second input operation obtained in a display region other than the display region corresponding to the first input operation.

S404: generating a second coordinate of an input point corresponding to the second input operation.

S405: identifying the first coordinate and the second coordinate, and determining the coordinate corresponding to the first display region and the coordinate corresponding to the second display region.

S406: obtaining address information which corresponds to the coordinate corresponding to the first display region.

S407: determining file address information which corresponds to the coordinate corresponding to the second display region according to a correspondence between coordinate information and the file address information of the second electronic device.

S408: generating and sending a data transmission control instruction carrying the file address information to the second electronic device.

S409: controlling the data transmission between an address corresponding to the file address information and an address corresponding to the address information in response to the data transmission control instruction.

S410: determining whether the sender of the data is the second electronic device; if the sender of the data is the second electronic device, executing step S411 to determine whether the transmitted data belongs to data of an application; executing step S412 to control the execution of the application, if the transmitted data belongs to data of an application.

No operation is executed, if the sender of the data is not the second electronic device or the transmitted data does not belong to the data of the application.

In this embodiment, the application may further be executed in the case where the data of the second electronic device is transmitted to the address corresponding to the address information and it is determined that the transmitted data is the data of the application. For example, a game is opened directly, when the game stored in the second electronic device is transmitted to the address corresponding to the address information. In this way, the user opens the application directly after transmitting the application by using the method according to the embodiment when the user wants to use the application in the second electronic device. It is simply and conveniently to be operated, and that the time for operating the device and opening the application by the user is saved.

The method for controlling data transmission according to the above-mentioned four embodiments of the present invention is applied in the first electronic device. A first display region of the first electronic device displays information of the first electronic device or a third electronic device. In the case where information of the first electronic device is displayed in the first display region, an input operation is detected in the first display region, and a coordinate of the input point corresponding to the input operation is generated. The obtained address information which corresponds to the coordinate corresponding to the first display region is the address information of the file stored in the first electronic device. In this case, a data transmission control instruction is generated and sent to the second electronic device, and data transmission between the address corresponding to the file address information and the address corresponding to the address information is controlled in response to the data transmission control instruction. Specifically, the data transmission between the first electronic device and the second electronic device is controlled.

In the case where the information of the third electronic device is displayed in the first display region of the first electronic device, the manner of detecting the input operation of the user in the first display region, generating the coordinate of the input point corresponding to the input operation, and then obtaining the address information corresponding to the coordinate corresponding to the first display region includes:

determining a file of the third electronic device which corresponds to the coordinate corresponding to the first display region; and

acquiring file address information of the third electronic device as the address information which corresponds to the coordinate corresponding to the first display region.

The address information of the file of the third electronic device displayed in the first display region of the first electronic device may be acquired in advance, and the correspondence between the file address information and the coordinate contained in the first display region may be established. Alternatively, wireless connection between the first electronic device and the third electronic device is established. The address information of the file is acquired after the file of the third electronic device is determined. Finally, the data transmission between the third electronic device and the second electronic device is controlled.

Moreover, in the case where the correspondence between the file address information of the third electronic device and the coordinates contained in the first display region is established in advance by the first electronic device, it is only necessary to ensure that the wireless connection between the second electronic device and the first electronic device is established, when the data transmission between the second electronic device and the third electronic device is controlled, the wireless connection between the first electronic device and the third electronic device is not needed to be established. It is only necessary for the first electronic device and the third electronic device to establish the connection with a third party such as a cloud, and the data transmission is performed through the third party. In this way, the data transmission between the two electronic devices can be implemented, even if there is long distance between the third electronic device and the first electronic device.

An electronic device is disclosed in another embodiment of the present invention. The device includes a display unit 101, a first detection unit 102, a processor 103, a communication unit 104 and a memory 105 which stores control code for controlling the operation of the processor.

The display interface of the display unit 101 includes at least two display regions; a first display region displays information of the first electronic device or a third electronic device, and a second display region displays file information of a second electronic device.

The first detection unit 102 is adapted to detect a first input operation and a second input operation. The first input operation is obtained in the first display region or the second display region, and the second input operation is obtained in a display region other than the display region corresponding to the first input operation.

The processor 103 is adapted to generate a first coordinate of an input point corresponding to the first input operation and a second coordinate of an input point corresponding to the second input operation; identify the first coordinate and the second coordinate, and determine the coordinate corresponding to the first display region and the coordinate corresponding to the second display region; obtain address information which corresponds to the coordinate corresponding to the first display region; determine file address information of the coordinate corresponding to the second display region according to a correspondence between coordinate information and the file address information of the second electronic device; and generate a data transmission control instruction carrying the file address information.

The communication unit 104 is adapted to send the data transmission control instruction to the second electronic device; and control data transmission between an address corresponding to the file address information and an address corresponding to the address information in response to the data transmission control instruction.

For the electronic device according to the embodiment, the user is only needed to perform an input operation in the first display region and the second display region of the display unit 101 of the electronic device, the first detection unit 102 may detect a first input operation and a second input operation. The processor 103 generates a first coordinate of an input point corresponding to the first input operation and a second coordinate of an input point corresponding to the second input operation; identifies the first coordinate and the second coordinate, and determines the coordinate corresponding to the first display region and the coordinate corresponding to the second display region; obtains the address information which corresponds to the coordinate corresponding to the first display region; determines file address information of the coordinate corresponding to the second display region according to the correspondence between coordinate information and the file address information of the second electronic device; and generates a data transmission control instruction carrying the file address information. The communication unit 104 sends the data transmission control instruction to the second electronic device; and controls data transmission between the address corresponding to the file address information and the address corresponding to the address information in response to the data transmission control instruction. The operation can be easy and convenient with short time and high efficiency, thereby it is solved the problem in the prior art of long time and low efficiency for data transmission due to the frequent operation of electronic devices by the user to accomplish data transmission.

Specifically, in this embodiment, the display interface of display unit 101 is an interactive interface, and the user may perform an input operation on the interactive interface, thereby the Human-Computer Interaction is implemented. The first detection unit 102 is a detection device such as a sensor, which may detect whether there is an input operation by the user on the display interface of the electronic device. The communication unit 104 may be a wireless communication module, which may receive data transmitted by the second electronic device, or transmit data to the second electronic device. The specific processing procedure of the processor 103 is shown in the content corresponding to FIG. 1 according to the method embodiment of the present invention, which will not be repeated any more herein.

Preferably, the specific manner for the processor 103 to obtain the address information which corresponds to the coordinate corresponding to the first display region includes:

determining whether there is a corresponding file to the coordinate corresponding to the first display region;

acquiring address information of the corresponding file as the address information which corresponds to the coordinate corresponding to the first display region, if there is the corresponding file; and

acquiring preset address information as the address information which corresponds to the coordinate corresponding to the first display region, if there is no corresponding file.

In this way, the electronic device may transmit the data to the file or send the data stored in the file to the second electronic device after executing the method for controlling data transmission, in the case where there is a file displayed in the first display region of the electronic device and the file is selected by the input operation of the user. The electronic device may receive the transmitted file and store the transmitted file directly in the first display region, i.e., the desktop of the first electronic device, after executing the method for controlling data transmission, in the case where there is no file in the first display region of the electronic device.

An electronic device is further disclosed in another embodiment of the present invention. This embodiment differs from the above-mentioned embodiment in that, the electronic device further includes a second detection unit adapted to detect whether the second electronic device is in the predetermined range of the electronic device.

The memory of the electronic device further stores control code for controlling the processor to acquire identification information of the first electronic device and establish wireless connection with the first electronic device; acquire file address information of the first electronic device; and generate a correspondence between the file address information of the first electronic device and coordinate information corresponding to the second display region for the second electronic device, in the case where it is detected by the second detection unit that the second electronic device is in the predetermined range of the electronic device.

Specifically, when the predetermined range refers to the display interface of the electronic device, the second detection unit may be a sensor, for detecting whether the second electronic device is placed on the display interface of the electronic device. A detection signal is generated if it is detected that the second electronic device is placed on the display interface of the electronic device. When the predetermined range refers to a region other than the electronic device, the second detection unit may be a generator which may emit RF signal, for detecting whether there is a second electronic device in the sensing range of the RF signal.

In the case where it is detected by the second detection unit that the second electronic device is in the predetermined range, the processor acquires the identification information of the first electronic device, establishes wireless connection with the first electronic device; acquires the file information of the first electronic device; and generates a correspondence between the file address information of the first electronic device and coordinate information corresponding to the second display region for the second electronic device.

Preferably, the memory of the electronic device further stores control code for controlling the processor to acquire input information corresponding to the first input operation; and determine the input information to be the predetermined information and acquire control instruction information corresponding to the predetermined information.

In this case, the specific manner for the processor of the electronic device to generate a data transmission control instruction carrying the file address information includes generating the data transmission control instruction carrying the file address information according to the control instruction information.

Specifically, the data transmission may refer to copying data and transmitting the copied data to a specified address; alternatively, the data transmission may refer to cutting data to a specified address. In this case, the input information of the user is different with respect to the different type of data transmission. The type of data transmission can be learnt by acquiring the input information corresponding to the first input operation.

Preferably, the memory of the electronic device further stores control code for controlling the processor to determine whether the sender of the data is the second electronic device after the data transmission is accomplished by the electronic device; and determine whether the transmitted data belongs to data of an application, if the sender of the data is the second electronic device; and generate a control instruction to control the execution of the application, if the transmitted data belongs to the data of the application.

In the case where it is determined by the processor of the electronic device that the data transmission is accomplished, the sender of the data is the second electronic device, and the transmitted data is the data of the application, then a control instruction is generated to control executing the application. In this way, the application of the second electronic device may be opened directly after being transmitted, and it is saved the time for operating the device and opening the application by the user.

It should be noted herein that, the first display region of the electronic device displays information of itself or the third electronic device. In the case where the first display region displays its own information, the first detection unit detects user input operation in the first display region, the processor generates a coordinate of the input point corresponding to the input operation. The obtained address information which corresponds to the coordinate corresponding to the first display region is the address information of the file stored in the first electronic device. In this case, the processor generates a data transmission control instruction, the communication unit sends the data transmission control instruction to the second electronic device, and data transmission between an address corresponding to the file address information and an address corresponding to the address information is controlled in response to the data transmission control instruction. Specifically, the data transmission between the first electronic device and the second electronic device is controlled.

The specific manner for the processor to obtain address information which corresponds to the coordinate corresponding to the first display region in the case where the first display region displays the information of the third electronic device includes:

determining a file of the third electronic device which corresponds to the coordinate corresponding to the first display region; and

acquiring file address information of the third electronic device as the address information which corresponds to the coordinate corresponding to the first display region.

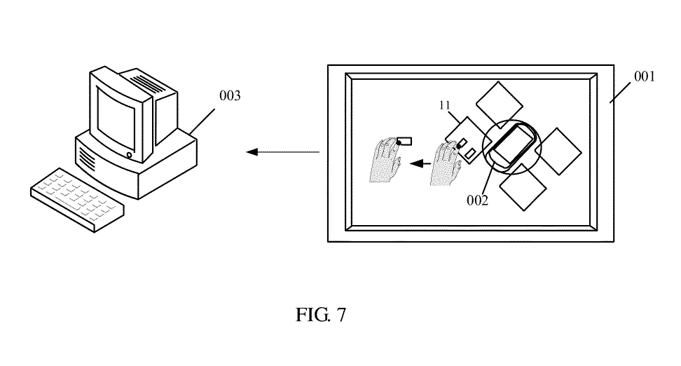

Referring to FIG. 7, after the user selects a file displayed in the second display region 11 of the electronic device 001, i.e., a certain file of the second electronic device 002, and drags the file to the first display region, then it is necessary for the electronic device 001 to transmit the received file to the third electronic device 003 since the information displayed in the first display region is the information of the third electronic device.

An animation effect may be played during data transmission to allow the user to experience the real procedure of file transmission during the file transmission.

Moreover, the address information of the file of the third electronic device displayed in the first display region of the electronic device may be acquired in advance, and the correspondence between the file address information and the coordinate contained in the first display region may be established in advance. Alternatively, wireless connection between the electronic device and the third electronic device is established, and the address information of the file is acquired after the file of the third electronic device is determined. Finally, the data transmission between the third electronic device and the second electronic device is controlled.

Furthermore, in the case where the correspondence between the file address information of the third electronic device and the coordinates contained in the first display region is established in advance by the electronic device, it is only necessary to ensure that the wireless connection between the second electronic device and the electronic device is established, when the data transmission between the second electronic device and the third electronic device is controlled, the wireless connection between the electronic device and the third electronic device is not needed to be established. It is only necessary for the electronic device and the third electronic device to establish the connection with a third party such as a cloud, and the data transmission is performed through the third party. In this way, the data transmission between the two electronic devices can be implemented, even if there is a long distance between the third electronic device and the electronic device.

Finally, it should further be noted that, in the present disclosure, relational terms such as “first” and “second” are used only to distinguish one entity or operation from the other entity or operation, but not necessarily demand or imply that there is actual relation or order among those entities and operations. Furthermore, the terms “including”, “containing”, or any other variations thereof means a non-exclusive inclusion, so that the process, method, article or device that includes a series of elements includes not only these elements but also other elements that are not explicitly listed, or further includes elements inherent in the process, method, article or device. Moreover, when there is no further limitation, the element defined by the wording “include(s) a . . . ” does not exclude the case that in the process, method, article or device that includes the element there are other same elements.

The embodiments of the present invention are described herein in a progressive manner, with the emphasis of each of the embodiments on the difference between it and the other embodiments; hence, for the same or similar parts between the embodiments, one can refer to the other embodiments.

The description of the embodiments herein enables those skilled in the art to implement or use the present invention. Numerous modifications to the embodiments will be apparent, and the general principle herein can be implemented in other embodiments without deviation from the spirit or scope of the present invention. Therefore, the present invention is not limited to the embodiments described herein, but in accordance with the widest scope consistent with the principle and novel features disclosed herein.

1. A method for controlling data transmission, which is applied in a first electronic device, a display interface of the first electronic device comprising at least two display regions; a first display region displaying information of the first electronic device or a third electronic device, and a second display region displaying file information of a second electronic device; the method comprising:
detecting a first input operation obtained in the first display region or the second display region;
generating a first coordinate of an input point corresponding to the first input operation;
detecting a second input operation obtained in a display region other than the display region corresponding to the first input operation;
generating a second coordinate of an input point corresponding to the second input operation;
identifying the first coordinate and the second coordinate, and determining the coordinate corresponding to the first display region and the coordinate corresponding to the second display region;
obtaining address information which corresponds to the coordinate corresponding to the first display region;
determining file address information which corresponds to the coordinate corresponding to the second display region according to a correspondence between coordinate information and the file address information of the second electronic device;
generating and sending a data transmission control instruction carrying the file address information to the second electronic device; and
controlling the data transmission between an address corresponding to the file address information and an address corresponding to the address information in response to the data transmission control instruction.

2. The method according to claim 1, wherein, before the detecting a first input operation, the method further comprises:
detecting the second electronic device being in a predetermined range of the first electronic device;
acquiring identification information of the second electronic device, and establishing wireless connection with the second electronic device;
acquiring the file address information of the second electronic device;
generating a correspondence between the file address information of the second electronic device and coordinate information corresponding to the second display region of the first electronic device; and
outputting the file information of the second electronic device.

3. The method according to claim 1, wherein, after the detecting a first input operation, the method further comprises:
acquiring input information corresponding to the first input operation; and
determining that the input information is predetermined information, and acquiring control instruction information corresponding to the predetermined information; and
the generating and sending a data transmission control instruction carrying the file address information to the second electronic device is: generating and sending the data transmission control instruction carrying the file address information to the second electronic device according to the control instruction information.

4. The method according to claim 1, wherein the obtaining address information which corresponds to the coordinate corresponding to the first display region comprises:
determining whether there is a corresponding file to the coordinate corresponding to the first display region;
acquiring address information of the corresponding file as the address information which corresponds to the coordinate corresponding to the first display region, if there is the corresponding file; and
acquiring preset address information as the address information which corresponds to the coordinate corresponding to the first display region, if there is no corresponding file.

5. The method according to claim 1, wherein, after the data transmission, the method further comprises:
determining whether the sender of the data is the second electronic device;
determining whether the transmitted data belongs to data of an application, if the sender of the data is the second electronic device; and
controlling the execution of the application, if the transmitted data belongs to the data of the application.

6. The method according to claim 1, wherein the obtaining address information which corresponds to the coordinate corresponding to the first display region in the case where the first display region displays the information of the third electronic device comprises:
determining a file of the third electronic device which corresponds to the coordinate corresponding to the first display region; and
acquiring file address information of the third electronic device as the address information which corresponds to the coordinate corresponding to the first display region.

7. An electronic device, comprising:
a display unit, a display interface of which comprising at least two display regions, wherein a first display region displays information of the electronic device or a third electronic device, and a second display region displays file information of a second electronic device;
a first detection unit, adapted to detect a first input operation and a second input operation, wherein the first input operation is obtained in the first display region or the second display region, and the second input operation is obtained in a display region other than the display region corresponding to the first input operation;
a processor, adapted to generate a first coordinate of an input point corresponding to the first input operation and a second coordinate of an input point corresponding to the second input operation; identify the first coordinate and the second coordinate, and determine the coordinate corresponding to the first display region and the coordinate corresponding to the second display region; obtain address information which corresponds to the coordinate corresponding to the first display region; determine file address information of the coordinate corresponding to the second display region according to a correspondence between coordinate information and the file address information of the second electronic device; and generate a data transmission control instruction carrying the file address information; and
a communication unit, adapted to send the data transmission control instruction to the second electronic device; and control data transmission between an address corresponding to the file address information and an address corresponding to the address information in response to the data transmission control instruction;
wherein the electronic device further comprises a memory storing control code for controlling the operation of the processor.

8. The electronic device according to claim 7, further comprising:
a second detection unit, adapted to detect whether the second electronic device is in a predetermined range of the electronic device;
wherein the memory further stores control code for controlling the processor to acquire identification information of the first electronic device and establish wireless connection with the first electronic device; acquire file address information of the first electronic device; and generate a correspondence between the file address information of the first electronic device and coordinate information corresponding to the second display region for the second electronic device, in the case where it is detected by the second detection unit that the second electronic device is in the predetermined range of the electronic device.

9. The electronic device according to claim 7, wherein the memory further stores control code for controlling the processor to acquire input information corresponding to the first input operation; and determine that the input information is predetermined information and acquire control instruction information corresponding to the predetermined information; and
the specific manner for the processor to generate a data transmission control instruction carrying the file address information comprises: generating the data transmission control instruction carrying the file address information according to the control instruction information.

10. The electronic device according to claim 7, wherein the specific manner for the processor to obtain address information which corresponds to the coordinate corresponding to the first display region comprises:
determining whether there is a corresponding file to the coordinate corresponding to the first display region;
acquiring address information of the corresponding file as the address information which corresponds to the coordinate corresponding to the first display region, if there is the corresponding file; and
acquiring preset address information as the address information which corresponds to the coordinate corresponding to the first display region, if there is no corresponding file.

11. The electronic device according to claim 7, wherein the memory further stores control code for controlling the processor to determine whether the sender of the data is the second electronic device after the data transmission is accomplished by the electronic device; determine whether the transmitted data belongs to data of an application, if the sender of the data is the second electronic device; and generate a control instruction to control the execution of the application, if the transmitted data belongs to the data of the application.

12. The electronic device according to claim 7, wherein the specific manner for the processor to obtain address information which corresponds to the coordinate corresponding to the first display region in the case where the first display region of the display unit displays the information of the third electronic device comprises: determining a file of the third electronic device which corresponds to the coordinate corresponding to the first display region; and
acquiring file address information of the third electronic device as the address information which corresponds to the coordinate corresponding to the first display region.
